(19) United States
(12) Patent Application Publication
(10) Pub. No.: US 2024/0168609 A1
(43) Pub. Date: May 23, 2024

(54) Method and Apparatus for Presenting Book Information

(71) Applicant: Beijing Zitiao Network Technology Co., Ltd., Haidian District, Beijing (CN)

(72) Inventors: Wenchang Huang, Beijing (CN); Rongqiang Huang, Beijing (CN)

(21) Appl. No.: 18/506,697

(22) Filed: Nov. 10, 2023

(30) Foreign Application Priority Data
Nov. 23, 2022 (CN) 202211470783.0

(51) Int. Cl. G06F 3/0483; G06F 3/0482

(52) U.S. Cl. CPC G06F 3/0483; G06F 3/0482

(57) ABSTRACT

Disclosed are a method and an apparatus for presenting book information. The method includes: retrieving, in response to a user's access request for a read history page, book basic information corresponding to first books, each first book being a book historically read by the user; retrieving presentation tags corresponding to respective first books, wherein the presentation tags are determined based on interactive information of respective first books; and displaying, on the read history page, the book basic information and the presentation tags corresponding to the first books.

### CROSS-REFERENCE TO RELATED APPLICATION(S)

This application claims priority to Chinese Application No. 202211470783.0 filed Nov. 23, 2022, the disclosure of which is incorporated herein by reference in its entity.

### FIELD

The present disclosure relates to electronic reading technologies, and more particularly, relates to a method and an apparatus for presenting book information.

### BACKGROUND

As electronic devices become increasingly popular, more and more users are accustomed to reading electronic books on an electronic book reader, instead of reading traditional paper books. To facilitate a user to locate the books he/she already read, the electronic book reader would provide a read history page to present the books historically read by the user. At present, the read history page presents relevant information of the user's historically read books in a reverse-chronological order with the latest reading time on top, as illustrated in FIG. 1, where the relevant information specifically includes: book covers, book titles, and result information on whether a book has been added to the shelf.

However, the relevant information of respective books currently presented on the read history page still needs improvement to facilitate a user to quickly locate a book of his/her interest to read.

### SUMMARY

One or more embodiments of the disclosure provide a method and an apparatus for presenting book information so as to present, on a read history page, a user more information related to the books he/she historically read, facilitating the user to locate a book.

According to a first aspect, there is provided a method for presenting book information, comprising:
retrieving, in response to a user's access request for a read history page, book basic information corresponding to first books, each first book being a book historically read by the user;
retrieving presentation tags corresponding to respective first books, wherein the presentation tags are determined based on interactive information of respective first books; and
displaying, on the read history page, the book basic information and the presentation tags corresponding to the first books.

According to a second aspect, there is provided an apparatus for presenting book information, comprising:
a first retrieval module configured to retrieve, in response to a user's access request for a read history page, book basic information corresponding to first books, each first book being a book historically read by the user;
a second retrieval module configured to retrieve presentation tags corresponding to respective first books, wherein the presentation tags are determined based on interactive information of respective first books; and
a first display module configured to display, on the read history page, the book basic information and the presentation tags corresponding to the first books.

According to a third aspect, there is provided a computer-readable storage medium having a computer program stored thereon, which, when executed by a computer, causes the computer to perform the method according to the first aspect.

According to a fourth aspect, there is provided an electronic device, comprising a memory and a processor, wherein the memory has executable codes stored thereon, and the processor, when executing the executable codes, performs the method according to the first aspect.

The method and apparatus provided according to embodiments of the disclosure comprise: retrieving, in response to a user's access request for a read history page, book basic information corresponding to first books, each first book being a book historically read by the user; retrieving presentation tags corresponding to respective first books, wherein the presentation tags are determined based on interactive information of respective first books; and displaying, on the read history page, the book basic information and the presentation tags corresponding to the first books. In the procedure, the presentation tags corresponding to respective first books historically read by the user may be determined based on the interactive information of the respective first books, and the presentation tags may characterize historical interactions between the user and the first books, so that more historical interactive information with respect to the first books may be provided to the user, i.e., the distinct interactive information between the user and different first books, thereby facilitating the user to locate a book.

### BRIEF DESCRIPTION OF THE DRAWINGS

To illustrate the technical solutions in the embodiments of the disclosure more clearly, the drawings referred to in the description infra will be introduced briefly. Apparently, the drawings described below are only directed to some embodiments of the disclosure. To those skilled in the art, alternative drawings may also be derived from these drawings without exercise of inventive efforts.

FIG. 1 is a schematic diagram of a conventional presentation of a read history page;

FIG. 2 is an implementation block diagram of an example embodiment disclosed according to the disclosure;

FIG. 3 is a flow diagram of a method for presenting book information according to embodiments of the disclosure;

FIGS. 4A and 4B are interface schematic diagrams of a book information presentation interface according to embodiments of the disclosure, respectively;

FIG. 5 is a schematic block diagram of a book information presenting apparatus provided according to embodiments of the disclosure; and

FIG. 6 is a schematic block diagram of an electronic device provided according to embodiments of the disclosure.

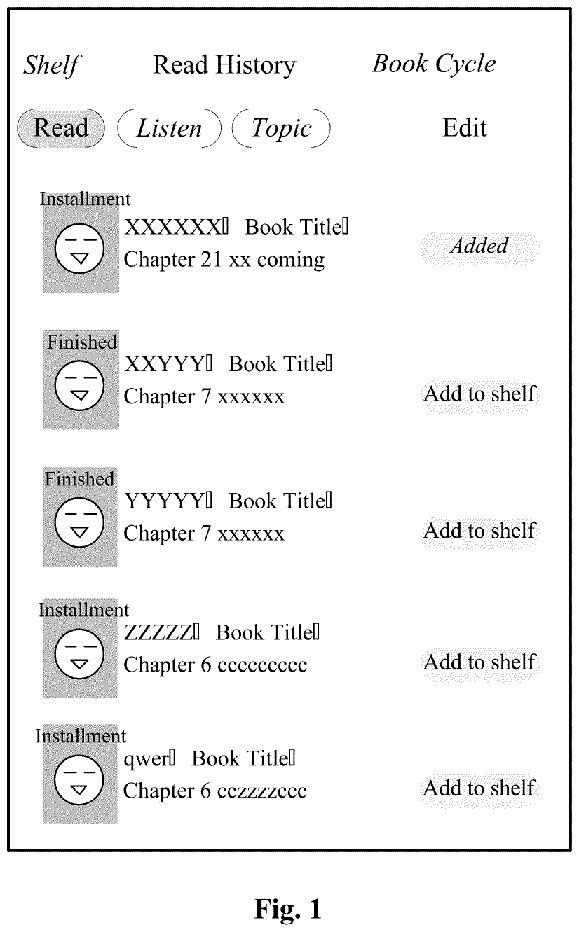

### DETAILED DESCRIPTION OF EMBODIMENTS

Hereinafter, technical solutions of the embodiments of the disclosure will be described in detail with reference to the accompanying drawings.

It is understood that before implementing the technical solutions disclosed in various embodiments of the disclosure, the type of personal information, scope of use, scenario of use, and the like shall be informed to the user and authorization from the user shall be obtained in appropriate manners according to relevant laws and regulations.

For example, in response to receiving a proactive request from a user, prompt information is sent to the user to expressly prompt the user that the requested operation to perform will access and use personal information of the user, such that the user may autonomously select whether to provide personal information to software or hardware such as an electronic device, an application, a server, or a memory medium which performs operations of the technical solutions of the disclosure based on the prompt information.

As an alternative and non-limitative implementation manner, in response to reception of a proactive request from the user, the prompt information sent to the user may for example be popped up and displayed in a textual manner in the popup window. In addition, the popup window may also bear a selection control for the user to select to “agree” or “reject” to provide personal information to the electronic device.

It is understood that the process of informing and obtaining user authorization as noted supra is only schematic, constituting no limitation to implementation manners of the disclosure, and other manners satisfying relevant laws and regulations may also be applied to implement the disclosure.

Embodiments of the disclosure disclose a method and an apparatus for presenting book information. Hereinafter, an application scenario and a technical idea of the method will be first introduced, specifically:

As noted supra, a current read history page usually shows relevant information of a user's historically read books in a reverse-chronological order with the latest reading time on top, where the relevant information includes: book covers, book titles, and result information on whether a book has been added to the shelf.

The book information presenting only the book covers, book titles and result information on whether the book has been added to the shelf, without any distinct information, cannot effectively identify different demands of a user on different historically read books as well as his/her historical interactions with the books, so that presentation of such information cannot help the user to quickly locate, on the read history page, a book of his/her interest to read.

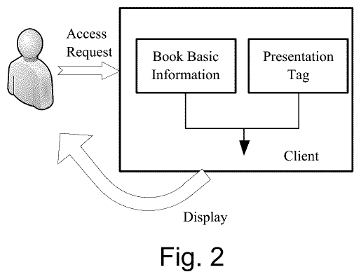

In view of the above, FIG. 2 illustrates an implementation scenario schematic diagram of an example embodiment disclosed herein. In the implementation scenario, a user may read electric books (books) via a client with an electronic book reading function, and when the user has a demand on viewing the electronic books he/she has historically read, the user may access the read history page, i.e., triggering an access request for the read history page. Upon detection of the access request, the client may, in response to the access request, obtain book basic information corresponding to first books from a server or from a preset storage area of the electronic device where the client is hosted, wherein each first book is a book historically read by the user; determine presentation tags corresponding to respective first books from the server or from the client itself, wherein the presentation tags are determined based on interactive information corresponding to the first books; and display, on the read history page, the book basic information and the presentation tags corresponding to the respective first books.

In this process, the client may determine the presentation tags corresponding to respective first books historically read by the user based on the interactive information of the first books. The presentation tags may characterize the user's historical interactions with the first books. In this manner, more historical interactive information with respect to the first books may be provided to the user, i.e., providing distinct interactive information between the user and different first books, which facilitates the user to search books.

Hereinafter, a method and an apparatus for presenting book information according to the disclosure will be described in detail in conjunction with specific example embodiments.

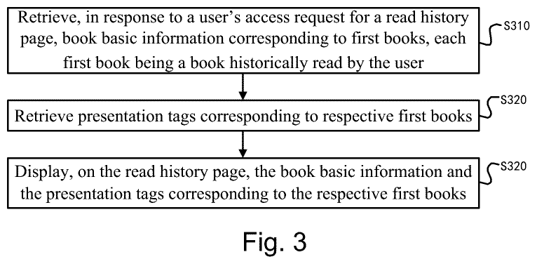

FIG. 3 illustrates a flow diagram of a method for presenting book information according to one embodiment of the disclosure. The method may be implemented via a client, and the client may be a client with an electronic book reading function such as an electronic book reader client or a browser client. The client may be installed on an electronic device which may be any device with computing and processing capabilities, e.g., a smart phone, a tablet computer, a desktop computer, an electronic book reader, etc. As illustrated in FIG. 3, the method comprises steps S310 through S330:

In step S330, book basic information corresponding to first books is retrieved in response to a user's access request for a read history page, each first book is a book historically read by the user.

In one implementation, the user may read an electronic book via a client, and a server corresponding to the client may record each electronic book read by the user. The client may provide a corresponding presentation function to the user when the user has a demand. Specifically, when the user has a demand on viewing the books historically read by him/her, he/she may click to access the read history page, i.e., triggering an access request for the read history page. The client detects the access request, and in response to the access request, the client may retrieve the stored book basic information corresponding to respective first books historically read by the user from the preset storage area (the preset storage area may be located in the electronic device where the client is hosted). Alternatively, the client may retrieve, in response to the access request, the book basic information corresponding to the respective first books historically read by the user from the server based on a user identifier of the user.

In one scenario, the book basic information may include, but is not limited to, book titles, book covers, and result information on whether a book has been added to the shelf.

Next, in step S320, presentation tags corresponding to respective first books are retrieved, wherein the presentation tags are determined based on interactive information of respective first books. In one implementation, the client may retrieve the presentation tags corresponding to the respective first books from the server. For example, the client may generate, in response to the access request, a request for querying information of the user's historically read books, and transmits the request to the server, and the server may determine, after receiving the request, the presentation tags corresponding to the respective first books based on corresponding interactive information between the user and the respective first books, and transmit the presentation tags corresponding to the respective first books to the client. The corresponding client thusly acquires the book basic information corresponding to the respective first books and the presentation tags corresponding to the respective first books.

In another implementation, the client may directly determine, based on the interactive information corresponding to the respective first books, the presentation tags corresponding to the respective first books. Herein, the interactive information may be retrieved from the server or read by the client from its corresponding preset storage area.

In one example embodiment, the interactive information may include an access channel and/or a historical reading status of the first book. Herein, the access channel of the first book may characterize information about from which channel the user accesses the first book. In one implementation, the access channel includes a search channel and a distribution channel, wherein the distribution channel may include at least one of, but not limited to, a book ranking list, a book recommendation video, and a community topic post.

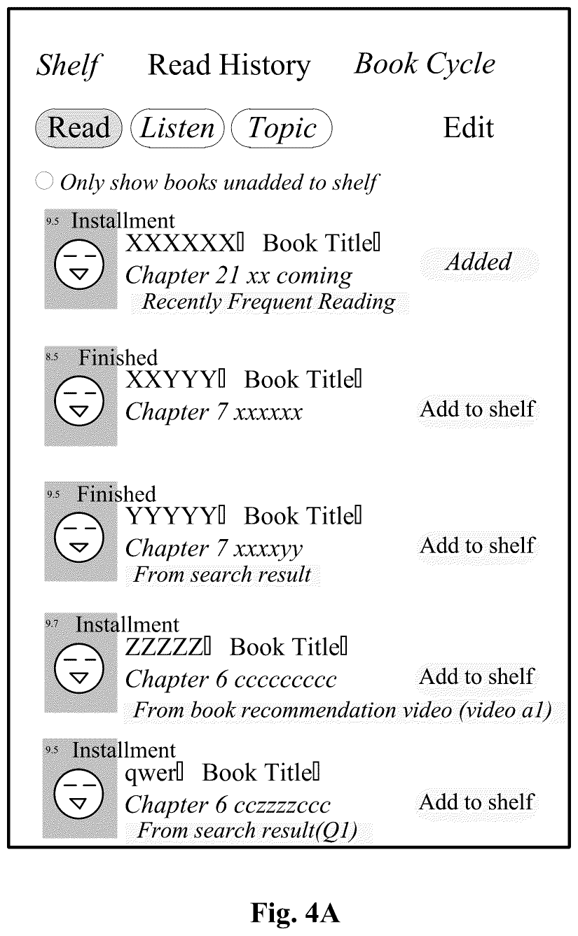

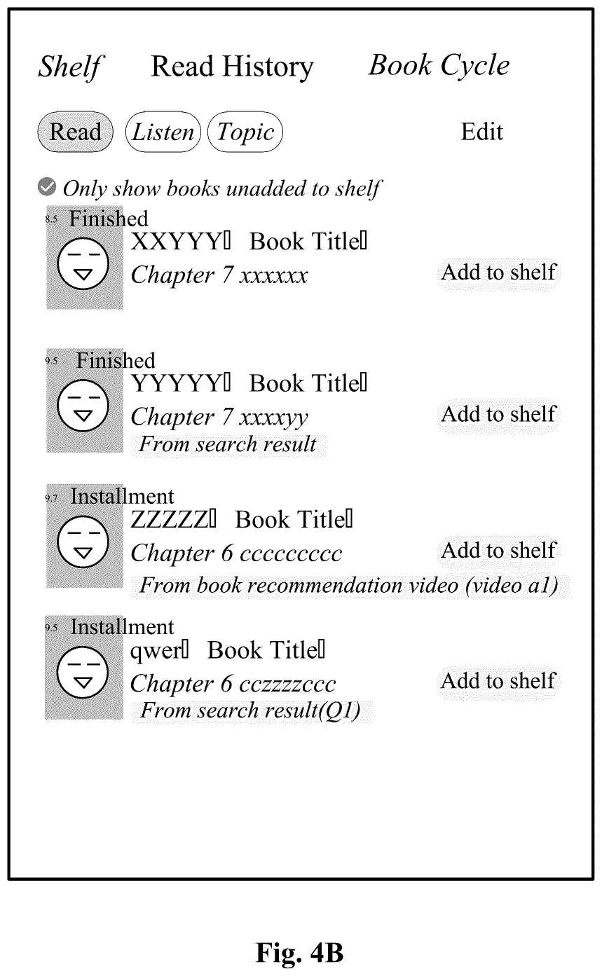

It may be understood that different access channels of the first books result in corresponding different presentation tags. For example, if the access channel corresponding to the first book is the search channel, the corresponding presentation tag is a tag characterizing that the first book is accessed from the search channel, e.g., the presentation tag may be “From search result,” as illustrated in FIG. 4A and FIG. 4B. If the access channel corresponding to the first book is a book recommendation video, the corresponding presentation tag is a tag characterizing that the first book is accessed from the book recommendation video, e.g., the presentation tag may be “From book recommendation video,” as illustrated in FIGS. 4A and 4B.

In one scenario, to guarantee that the user may access the latest interactive information with respect to the first book, the presentation channel corresponding to the first book may be determined based on the latest access channel of the first book.

The historical reading status may include progress of the user's reading a corresponding first book (for example, xx chapters finished; for another example, xx chapters left) and/or reading frequency (for example, frequency degree such as high/medium/low may be presented; for another example, number of times of reading in recent n days may be presented). It may be understood that the reading progresses and/or reading frequencies of the user with respect to the first books may be different, and thus the presentation tags corresponding to the first books are also different.

Different presentation tags may present distinct interactive information of the user with respect to respective historically read first books. By characterizing the user's different reading interests with respect to different first books, the user may make a better decision on which book to be continued to read.

In one example embodiment, step S230 may comprise step 11, in which in a case that the historical reading status includes a latest reading progress and a latest reading frequency, if the latest reading progress corresponding to the first book exceeds a first progress threshold and its latest reading frequency exceeds a first frequency threshold, a preset Recently Frequent Reading tag serves as the presentation tag corresponding to the first book. Herein, the first progress threshold and the first frequency threshold may be set dependent on actual situations. The first progress threshold may be set to ten chapters, for example, and the first frequency threshold may be set to three times in recent seven days, for example. If the number of times of the user's reading the first book in recent seven days exceeds three times and the number of currently read chapters of the first book exceeds 10 chapters, the preset Recently Frequent Reading tag may serve as the presentation tag for the first book.

In this implementation, in a case that the historical reading status includes the latest reading process and the latest reading frequency, if the latest reading progress corresponding to the first book exceeds the first progress threshold and its latest reading frequency exceeds the first frequency threshold, it may be characterized that the user frequently reads the first book recently, which may characterize, to a certain extent, that the first book is likely the book of interest to the user recently. Correspondingly, in order to allow the user to know the reading status of a historically read book more clearly so as to reduce occurrence of a situation that the user forgets the book title and cannot quickly locate the first book, a preset Recent Reading tag may serve as the presentation tag for the first book. As illustrated in FIGS. 4A and 4B, the Recent Reading tag corresponding to First Book 1 is “Recent Reading.”

In another embodiment, the presentation tag for the first book may also be determined for the first book by the server based on the latest reading process and the latest reading frequency. Correspondingly, in this case, the client may directly retrieve, from the server, the presentation tag (e.g., the Recently Frequent Reading tag) corresponding to the first book.

In a further embodiment, step S320 may comprise step 12, in which in a case that the historical reading status includes the latest reading progress, if the latest reading progress corresponding to the first book exceeds a second reading threshold, the Reading Progress tag characterizing the latest reading progress, or the Progress Delay tag characterizing the number of currently unread chapters, may serve as the presentation tag corresponding to the first book.

In this implementation, the historical reading status includes the latest reading progress. Considering a case that some book is very long and the user will spend much time on finishing the book, in order to avoid a circumstance that the user has not read a certain previously frequently read book over a long time and then cannot quickly locate the book due to failing to recall the book title (title), if the latest reading progress corresponding to the first book exceeds the second progress threshold, it may be deemed that the user likely favors reading this first book. Correspondingly, to facilitate prompting the user so as to help the user to recall the book more quickly, the client uses a Reading Progress tag (e.g., “xx % finished” characterizing the latest reading progress, or a Progress Delay tag characterizing the number of currently unread chapters (e.g., “xx chapters left”) as the presentation tag corresponding to the first book.

In a further example embodiment, step S320 may comprise step 13, in which in a case that the historical reading status includes the latest reading frequency, if the latest reading frequency corresponding to the first book exceeds the second frequency threshold, the Frequent Reading tag characterizing the latest reading frequency serves as the presentation tag corresponding to the first book.

In this implementation, in a case that the historical reading status includes the latest reading frequency, if the latest reading frequency corresponding to the first book exceeds the second frequency threshold, it may be characterized that the user frequently reads the first book recently, which, to a certain extent, may characterize that the first book is likely the book of the user's interest recently. Correspondingly, to enable the user to know the reading status of the historically read book more clearly and reduce occurrence of a situation in which the user forgets the book title and cannot quickly locate the first book, the Frequent Reading tag (which, for example, may be “Highly Frequent Reading” or “Multiple Times of Reading in This Week”) characterizing the latest reading frequency is used as the presentation tag corresponding to the first book, so as to facilitate the user to quickly recall a situation about the book.

In one embodiment, in a case that the interactive information includes the access channel and the historical reading status, it likely occurs that a plurality of presentation tags are determined based on the interactive information corresponding to the first book, e.g., determining both the channel tag (presentation tag) characterizing the access channel of the first book and the reading status tag (presentation tag) characterizing the historical reading status of the first book. To guarantee conciseness of the read history page and avoid annoyance to the user caused by excessive information display, it is allowed to only present one of the presentation tags for each first book. Specifically, in a case that the first book has both the channel tag characterizing its access channel and the reading status tag characterizing its historical reading status, priorities of the two tags may be first determined, so that if it is determined that a priority corresponding to the reading status tag (e.g., the Recently Frequent Reading tag) is higher than a priority corresponding to the channel tag, the reading status tag is used as the presentation tag corresponding to the first book.

After the client retrieves the book basic information and presentation tags of respective first books, in step S330, the book basic information and the presentation tags corresponding to the respective first books are displayed on the read history page. In this step, the client may display the book basic information and the presentation tags corresponding to the respective first books on the read history page in a reverse-chronological order of the respective first books with the latest reading time on top.

In one implementation, the client may also retrieve the book basic information corresponding to respective second books the user historically read, and display the book basic information corresponding to the respective second books on the read history page. That is, the client may display, on the read history page, the book basic information and the presentation tags corresponding to the respective first books, and the book basic information corresponding to the respective second books according to a reverse-chronological order of the respective first books and the respective second books with the latest reading time on top.

It is understood that reference to “first” in the first books and reference to “second” in the second books are only intended for distinguishing whether the books have corresponding presentation tags, without other limiting implications.

In one implementation, to enhance user experience and provide better services to the user, in a case that the presentation tags corresponding to the first books are determined based on access channels, the client may also display channel identifiers of the access channels of the first books corresponding to the book basic information corresponding to respective first books and the presentation tags characterizing the corresponding access channels. The user may trigger a channel identifier to access the channel interface corresponding to the access channel. The channel interface generally displays more books with certain similarity to the first book, so that the user may filter books of potential interest to him/her, which may have an effect of recommending books to the user, thereby satisfying the user's demands on new books.

Correspondingly, in one embodiment, step S330 may comprise displaying, in a case that the presentation tags are determined based on the access channels of the corresponding first books, the book basic information corresponding to the respective first books, the presentation tags characterizing the corresponding access channels, and the channel identifiers of the corresponding access channels, and triggering of the channel identifiers may access the channel interfaces corresponding to the access channels.

In one embodiment, in a case that the access channel is the search channel, the channel identifier is a corresponding search page identifier, and the channel interface is a search page presentation interface. Herein, the search page presentation interface may present a plurality of books with titles similar to the book title of a corresponding first book, or may present a plurality of books of the same author of the corresponding first book, so that the user may reselect a book of his/her interest from among the books presented in the search page presentation interface.

In another embodiment, in a case that the access channel is the book recommendation video, the channel identifier is a corresponding video identifier, and the channel interface is a video presentation interface corresponding to the video identifier. Herein, a corresponding book recommendation video may be presented on the video presentation interface. In one case, the book recommendation video may recommend a plurality of books of certain similarity to the corresponding first book (e.g., they are all historical novels, science fiction novels, etc.), so that the user may reselect a book of his/her interest from the books recommended in the book recommendation video. In another case, the book recommendation video may include more introduction information about the first book, so that the user may better understand the first book via the book recommendation video, which facilitates the user to decide on whether to continue reading the first book, thereby enhancing the user's reading experience.

In a further embodiment, the access channel is the community topic post, the channel identifier is a corresponding topic post identifier, and the channel interface is a topic post presentation interface corresponding to the topic post identifier. Herein, a plurality of books with certain similarity to the corresponding first book may be presented in the topic post presentation interface, so that the user may filter books of his/her interest. The topic post presentation interface may also present comments and discussions of other users with respect to the first book, so that the user may better understand the first book via the contents presented by the topic post presentation interface, which helps the user to decide on whether to continue reading the first book, thereby enhancing the user's reading experience.

In this embodiment, the client may determine presentation tags corresponding to respective first books the user historically read based on the interactive information of the first books. The presentation tags may characterize historical interactions of the user with the first books, so that more historical interactive information of the first books may be provided to the user, i.e., providing distinct interactive information between the user and different first books, thereby facilitating the user to search books.

The presentation tags corresponding to the first books may facilitate the user in screening various books, e.g., in a case that a presentation tag is a tag characterizing that a book is accessed via a search channel, it may be characterized that the book is accessed by the user by proactive search. This kind of books are generally of more interest to the user to read. This information may be provided to the user by the presentation tag characterizing that the books are accessed from the search channel, so as to facilitate the user to quickly locate such kind of books, thereby enhancing user experience.

In one embodiment, the book basic information may include result information on whether the corresponding first book has been added to the shelf. Correspondingly, the read history page further presents a target filter control that only shows the books unadded to the shelf. The method may further comprise displaying, in response to a trigger request for the target filter control, on the read history page, the book basic information and the presentation tags corresponding to the first books unadded to the shelf.

In this implementation, the read history page presents a target filter control indicative of only showing books unadded to the shelf, as illustrated in FIGS. 4A and 4B. The user may trigger the target filter control (by checking the control in front of the “only show books unadded to the shelf”, so that it changes to a solid circle from the hollow circle illustrated in FIG. 4A, with a check symbol displayed in the solid circle). The client detects the trigger request for the target filter control from the user, filters the books unadded to the shelf from among the displayed first books, and displays, on the read history page, the book basic information and the presentation tags corresponding to the first books unadded to the shelf, as illustrated in FIG. 4B. By only showing the book basic information and the presentation tags corresponding to the first books unadded to the shelf on the read history page, the user may view the books unadded to the shelf more conveniently, avoiding visual interferences from those “old” books already added to the shelf (the “old” here is termed relative to those books unadded to the shelf, which may refer to those books already added to the shelf, frequently used and/or having been completely read by the user), thereby enhancing presentation efficiency and search speed of the user in finding a “new” book he/she desires to read.

Considering that the user might have a demand on transferring at least one book (respective first books and/or respective second books) displayed on the read history page to a folder from which he/she frequently (usually) selects a book to read, so that he/she may locate the corresponding book more quickly, in one embodiment, the method may further comprise the following operations to provide a better service to the user.

In response to a first operation of adding to a designated folder triggered for a first target book in the first books unadded to the shelf, the first target book is transferred to the designated folder. The designated folder is a shelf designated to a user or a folder pre-created by the user, wherein the first target book may be any book in the first books unadded to the shelf.

To provide more and better services to the user and enhance user experience, in one embodiment, the method may further comprise: transferring, in response to an automatic classification instruction, based on kinds of respective first books unadded to the shelf, the respective first books unadded to the shelf to a folder matching their respective kinds.

In this implementation, the folder matching respective kinds of the books may refer to a folder with a name matching the kind of the first book or a folder already storing books of a kind matching the kind of the first book. For example, if the name of a folder is ancient romantic novels, and the books of the kind of ancient romantic novels may be correspondingly stored therein, i.e., transferring the first books of the kind of ancient romantic novels into the folder. For example, if Folder 1 already stores books of the kind of history, the first books of the kind of history may be correspondingly transferred into Folder 1.

With respective first books unadded to the shelf transferred to folders matching their kinds based on their kinds, the user may view the respective first books from the corresponding folders, which facilitates the user to know the kind of a book, further helping the user to decide on whether to continue reading the book.

In one embodiment, the book basic information may include a book cover. The method may further comprise retrieving score information corresponding to respective first books; and displaying, on the read history page, book covers incorporating the score information of the respective first books. In this implementation, in order to provide better services to the user, the client further provides the user with the score information corresponding to respective first books, so that the user may decide on whether to continue reading a first book based on its score information. As illustrated in FIGS. 4A and 4B, on the read history page, the score information corresponding to respective first books is incorporated onto the book covers to display, which may provide more reference information for the user's book selection decision without occupying display height of the page, and thusly may enhance conciseness of the display effect of the page to a certain extent, ensuring the user's view experience.

As illustrated in FIGS. 4A and 4B, the book statuses of respective first books (and second books) may also be incorporated in their book covers to display, whereby more reference information for the user's book selection is provided, wherein the book status includes a “finished” status and an “installment” status.

What have been described supra are specific example embodiments of the disclosure, and other embodiments also fall within the scope of the appended claims. In some circumstances, the actions or steps limited in the claims may be carried out in an order different from those described in the embodiments, which may still achieve a desired effect. In addition, the process depicted in the drawings does not necessarily follow the specific sequence or successive sequence as illustrated, which can also achieve a desired effect. In some implementations, multi-task processing and parallel processing are also allowable or can be advantageous.

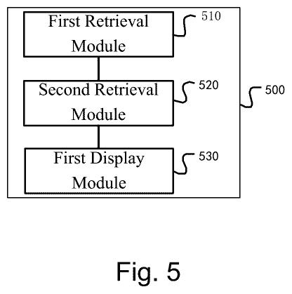

Corresponding to the method embodiments described supra, embodiments of the disclosure provide an apparatus 500 for presenting book information, the schematic block diagram of which is illustrated in FIG. 5, comprising:
a first retrieval module 510 configured to retrieve, in response to a user's access request for a read history page, book basic information corresponding to first books, each first books being a book historically read by the user;
a second retrieval module 520 configured to retrieve presentation tags corresponding to the respective first books, wherein the presentation tags are determined based on interactive information of respective first books; and
a first display module 530 configured to display, on the read history page, the book basic information and the presentation tags corresponding to the respective first books.

In one implementation, the interactive information comprises an access channel and/or a historical reading status of a corresponding first book.

In one implementation, the access channel comprises a search channel and a distribution channel, wherein the distribution channel comprises at least one of: a book ranking list, a video book recommendation, and a community topic post.

In one implementation, the first display module is specifically configured to display, in a case that the presentation tags are determined based on respective access channels of the corresponding first books, the book basic information corresponding to the respective first books, presentation tags characterizing corresponding access channels and respective channel identifiers of the corresponding access channels, and trigger the channel identifiers to access channel interfaces corresponding to the access channels.

In one implementation, in a case that the access channels are search channels, the channel identifiers are corresponding search page identifiers, and the channel interfaces are search page presentation interfaces.

In a case that the access channels are book recommendation videos, the channel identifiers are corresponding video identifiers, and the channel interfaces are video presentation interfaces corresponding to the video identifiers.

In a case that the access channels are community topic posts, the channel identifiers are corresponding topic post identifiers, and the channel interfaces are topic post interfaces corresponding to the topic post identifiers.

In one implementation, the second retrieval module 520 is specifically configured to: in a case that the historical reading status comprises a latest reading progress and a latest reading frequency, if the latest reading progress of a first book exceeds a first progress threshold and the latest reading frequency exceeds a first frequency threshold, use a preset Recently Frequent Reading tag as the presentation tag corresponding to the first book; or
in a case that the historical reading status comprises a latest reading progress, if the latest reading progress corresponding to a first book exceeds a second progress threshold, use a Reading Progress tag characterizing the latest reading progress or a Progress Delay tag characterizing a number of currently unread chapters as the presentation tag corresponding the first book; or
in a case that the historical reading status comprises a latest reading frequency, if the latest reading frequency of a first book exceeds a second frequency threshold, use a Frequent Reading tag characterizing the latest reading frequency as the presentation tag corresponding to the first book.

In one implementation, the first book is also labelled with a channel tag characterizing its access channel.

The second retrieval module 520 is specifically configured to use the Recently Frequent Reading tag as the presentation tag corresponding to the first book if it is determined that a priority corresponding to the Recently Frequent Reading tag is higher than a priority corresponding to the channel tag.

In one implementation, the book basic information comprises: result information on whether corresponding first books have been added to a shelf; and the read history page further presents a target filter control indicating only displaying books unadded to the shelf; and
the apparatus further comprises:
a second display module (not shown) configured to display on the read history page, in response to a trigger request for the target filter control, the book basic information and the presentation tags corresponding to the first books unadded to the shelf.

In one implementation, the apparatus further comprises:

a first transferring module (not shown) configured to transfer, in response to a first operation of adding to a designated folder triggered for a first target book in the first books unadded to the shelf, the first target book to the designated folder, the designated folder being a shelf designated to a user or a folder pre-created by the user.

In one implementation, the apparatus further comprises:

a second transferring module (not shown) configured to transfer, in response to an automatic classification instruction, based on kinds of respective first books unadded to the shelf, the respective first books unadded to the shelf to folders matching their types.

In one implementation, the book basic information comprises a book cover; and the apparatus further comprises:
a third retrieval module (not shown) configured to retrieve score information corresponding to the respective first books; and
a third display module (not shown) configured to display, on the read history page, book covers incorporating the score information corresponding to the respective first books. In one implementation, the apparatus further comprises:

a fourth retrieval module (not shown) configured to retrieve book basic information corresponding to second books, each second book being a book historically read by the user; and

the first display module 530 is specifically configured to display the book basic information and the presentation tags corresponding to the respective first books, and the book basic information corresponding to the respective second books.

The apparatus embodiments correspond to the method embodiments. Detailed description of the apparatus embodiments may refer to that of the method embodiments, which will not be detailed here. The apparatus claims are derived based on the corresponding method embodiments, achieving same technical effects as the corresponding method embodiments, which may refer to the corresponding method embodiments.

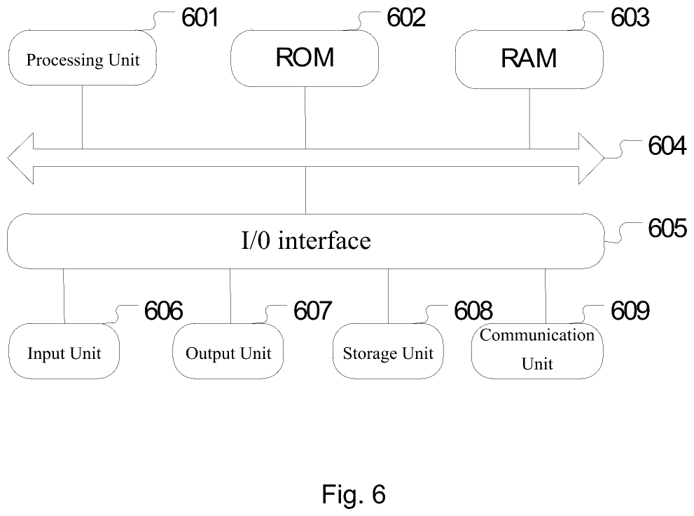

Hereinafter, refer to FIG. 6, which illustrates a structural schematic diagram of an electronic device 600 adapted to implement the embodiments of the disclosure. The electronic device illustrated in FIG. 6 is only an example, which shall not constitute any limitation to the functions and scope of use of the embodiments of the disclosure.

As illustrated in FIG. 6, the electronic device 600 may comprise a processing unit (e.g., a Center Processing Unit, a Graphic Processing Unit, etc.) 601, which may execute various suitable actions and processing based on the program stored in a read-only memory (ROM) 602 or a program loaded in the random-access memory (RAM) 603 from a storage unit 608. The RAM 603 can also store all kinds of programs and data necessary to operation of the electronic device 600. The processing unit 601, ROM 602 and RAM 603 are interconnected to each other via a bus 604. The input/output (I/O) interface 605 is also connected to the bus 604.

Generally, the following devices may be connected to the I/O interface 605: an input unit 606 including, e.g., a touch screen, a touch pad, a keypad, or a mouse; an output unit 607, e.g., a LCD (Liquid Crystal Display), a loudspeaker, or a vibrator; a storage unit 608 such as a magnetic tape, a hard disk; and a communication unit 609. The communication unit 609 allows the electronic device 600 to exchange information/data with other devices via wireless or wired communication. Although FIG. 6 illustrates the electronic device 600 comprising various components, it is understood that it is not required to implement or possess all of the illustrated components. Alternatively, more or less components may be implemented or included. Each block illustrated in FIG. 6 may represent one component, and may also represent more components as needed.

Particularly, according to the embodiments of the disclosure, the processes described with reference to the above flow diagram may be implemented as computer software programs. For example, embodiments of the disclosure comprise a computer program product comprising a computer program carried on the computer-readable medium, the computer program including program codes for performing the methods illustrated in the flow diagram. In such embodiments, the computer program may be downloaded and installed from the network via the communication unit 609, or installed from the storage unit 608, or installed from the ROM 602. When the computer program is executed by the processing unit 601, the actions defined by the methods according to the embodiments of the disclosure are implemented.

Embodiments of the disclosure further provide a computer-readable storage medium having a computer program stored thereon, which, when executed on a computer, causes the computer to perform the method for presenting book information according to the disclosure.

It is noted that, the computer-readable medium described in the embodiments of the disclosure may be a computer-readable signal medium or a computer-readable storage medium or any combination thereof. The computer-readable storage medium for example may be, but is not limited to, electric, magnetic, optical, electro-magnetic, infrared or semiconductor system, apparatus or device, or any combination thereof. More specific examples of the computer-readable storage medium include, but are not limited to, an electric connection via one or more wires, a portable computer magnetic disk, hard disk, random access memory (RAM), read-only memory (ROM), erasable programmable read-only memory (EPROM or flash memory), optical fiber, portable compact-disc read-only storage medium (CD-ROM), optical storage device, magnetic storage device, or any appropriate combination thereof. In the embodiments of the disclosure, the computer-readable storage medium may refer to any tangible medium including or storing a program that can be used by an instruction executing system, apparatus or device or used by a combination thereof. Moreover, in the embodiments of the disclosure, the computer-readable signal medium may include data signals in the base band or propagated as a part of a carrier, in which the computer-readable program codes are carried. This propagated data signals may take on various forms, including, but not limited to, electromagnetic signals, optical signals, or any suitable combination thereof. The computer-readable signal medium may also be any computer-readable medium other than the computer-readable storage medium, which computer-readable signal medium may transmit, propagate, or transfer a program used by the instruction executing system, apparatus or device, or used in combination therewith. The program codes stored on the computer-readable medium may be transmitted via any appropriate medium including, but is not limited to, wires, cables, RFs (Radio Frequencies), etc., or any appropriate combination thereof.

The computer-readable medium noted supra may be included in the electronic device, or may be standalone, without being assembled to the electronic device. The computer-readable medium carries one or more programs which, when being executed by the electronic device, causes the electronic device to: retrieve, in response to a user's access request for a read history page, book basic information corresponding to first books, each first book being a book historically read by the user; retrieve presentation tags corresponding to respective first books, wherein the presentation tags are determined based on interactive information of respective first books; and display, on the read history page, the book basic information and the presentation tags corresponding to the respective first books.

The computer-program codes for performing the operations in the embodiments of the disclosure may be compiled with one or more programming languages or a combination thereof; the programming languages comprise object-oriented programming languages, e.g., Java, Smalltalk, C++, and further comprise traditional procedural programming languages, such as “C” language or similar programming languages. The program codes can be executed completely on the user computer, partially on the user computer, as an independent software package, partially on the user computer and partially on the remote computer, or completely on the remote computer or server. In a scenario where a remote computer is involved, the remote computer can be connected to the user computer via any type of network, including local area network (LAN) and wide area network (WAN), or to the external computer (e.g., connected via Internet using the Internet service provider).

The embodiments in the specification are described in a progressive manner, and same or similar portions between the embodiments may refer to each other; each embodiment focuses on differences from other embodiments. Particularly, for the storage-medium and computer-device embodiments, since they are substantially similar to the method embodiments, they are described relatively briefly, and relevant portions may refer to the description of the method embodiments.

Those skilled in the art would be aware that, in one or more examples noted supra, the functions described in the embodiments of the disclosure may be implemented by hardware, software, firmware, or any combination thereof. When such functions are implemented by software, these functions may be stored in the computer-readable medium, or may be transmitted as one or more instructions or codes on the computer-readable medium.

The objectives, technical solutions, and benefits of the embodiments of the disclosure have been described in further detail via specific examples. It is understood that, what have been described are only specific implementations of the embodiments of the disclosure, which are not intended for limiting the scope of protection of the disclosure; any alterations, equivalent substitutions, and modifications made based on the technical solutions of the disclosure shall fall within the scope of protection of the disclosure.

I/We claim:

1. A method for presenting book information, comprising:
retrieving, in response to a user's access request for a read history page, book basic information corresponding to first books, each first book being a book historically read by the user;
retrieving presentation tags corresponding to respective first books, wherein the presentation tags are determined based on interactive information of respective first books; and
displaying, on the read history page, the book basic information and the presentation tags corresponding to the first books.

2. The method according to claim 1, wherein the interactive information comprises an access channel and/or a historical reading status of a corresponding first book.

3. The method according to claim 2, wherein the access channel comprises a search channel and a distribution channel, and wherein the distribution channel comprises at least one of: a book ranking list, a book recommendation video, and a community topic post.

4. The method according to claim 2, wherein displaying, on the read history page, the book basic information and the presentation tags corresponding to the first books comprises:
displaying, in a case that the presentation tags are determined based on respective access channels of the corresponding first books, the book basic information corresponding to the respective first books, presentation tags characterizing corresponding access channels, and respective channel identifiers of the corresponding access channels, and triggering the channel identifiers to access channel interfaces corresponding to the access channels.

5. The method according to claim 4, wherein in a case that the access channels are search channels, the channel identifiers are corresponding search page identifiers, and the channel interfaces are search page presentation interfaces;
in a case that the access channels are book recommendation videos, the channel identifiers are corresponding video identifiers, and the channel interfaces are video presentation interfaces corresponding to the video identifiers; and
in a case that the access channels are community topic posts, the channel identifiers are corresponding topic post identifiers, and the channel interfaces are topic post interfaces corresponding to the topic post identifiers.

6. The method according to claim 2, wherein retrieving the presentation tags corresponding to the respective first books comprises:
in a case that the historical reading status comprises a latest reading progress and a latest reading frequency, upon determining that the latest reading progress of a first book exceeds a first progress threshold and the latest reading frequency exceeds a first frequency threshold, using a preset Recently Frequent Reading tag as the presentation tag corresponding to the first book; or
in a case that the historical reading status comprises a latest reading progress, upon determining that the latest reading progress corresponding to a first book exceeds a second progress threshold, using a Reading Progress tag characterizing the latest reading progress or a Progress Delay tag characterizing a number of currently unread chapters as the presentation tag corresponding the first book; or
in a case that the historical reading status comprises a latest reading frequency, upon determining that the latest reading frequency of a first book exceeds a second frequency threshold, using a Frequent Reading tag characterizing the latest reading frequency as the presentation tag corresponding to the first book.

7. The method according to claim 6, wherein the first book is also labelled with a channel tag characterizing its access channel; and
using the preset Recently Frequent Reading tag as the presentation tag corresponding to the first book comprises:
using the Recently Frequent Reading tag as the presentation tag corresponding to the first book upon determining that a priority corresponding to the Recently Frequent Reading tag is higher than a priority corresponding to the channel tag.

8. The method according to claim 1, wherein the book basic information comprises: result information on whether corresponding first books have been added to a shelf; and the read history page further presents a target filter control indicating only displaying books unadded to the shelf; and
the method further comprises:
displaying on the read history page, in response to a trigger request for the target filter control, the book basic information and the presentation tags corresponding to the first books unadded to the shelf.

9. The method according to claim 8, further comprising:
transferring, in response to a first operation of adding to a designated folder triggered for a first target book in the first books unadded to the shelf, the first target book to the designated folder, the designated folder being a shelf designated to a user or a folder pre-created by the user.

10. The method according to claim 8, further comprising:
transferring, in response to an automatic classification instruction, based on kinds of respective first book unadded to the shelf, the first books unadded to the shelf to folders matching their respective kinds.

11. The method according to claim 1, wherein the book basic information comprises a book cover; and the method further comprises:
retrieving score information corresponding to the respective first books; and
displaying, on the read history page, book covers incorporating the score information corresponding to the respective first books.

12. The method according to claim 1, further comprising:
retrieving book basic information corresponding to second books, each second book being a book historically read by the user; and
displaying, on the read history page, the book basic information and the presentation tags corresponding to the first books comprises:
displaying the book basic information and the presentation tags corresponding to the respective first books, and the book basic information corresponding to the respective second books.

13. An electronic device, comprising:
a memory storing a computer program thereon; and
a processor for execution of the computer program in the memory to perform:
retrieving, in response to a user's access request for a read history page, book basic information corresponding to first books, each first book being a book historically read by the user;
retrieving presentation tags corresponding to respective first books, wherein the presentation tags are determined based on interactive information of respective first books; and
displaying, on the read history page, the book basic information and the presentation tags corresponding to the first books.

14. The electronic device according to claim 13, wherein the interactive information comprises an access channel and/or a historical reading status of a corresponding first book.

15. The electronic device according to claim 14, wherein the access channel comprises a search channel and a distribution channel, and wherein the distribution channel comprises at least one of: a book ranking list, a book recommendation video, and a community topic post.

16. The electronic device according to claim 14, wherein the processor for execution of the computer program in the memory is further to perform:
displaying, in a case that the presentation tags are determined based on respective access channels of the corresponding first books, the book basic information corresponding to the respective first books, presentation tags characterizing corresponding access channels, and respective channel identifiers of the corresponding access channels, and triggering the channel identifiers to access channel interfaces corresponding to the access channels.

17. The electronic device according to claim 16, wherein in a case that the access channels are search channels, the channel identifiers are corresponding search page identifiers, and the channel interfaces are search page presentation interfaces;
in a case that the access channels are book recommendation videos, the channel identifiers are corresponding video identifiers, and the channel interfaces are video presentation interfaces corresponding to the video identifiers; and
in a case that the access channels are community topic posts, the channel identifiers are corresponding topic post identifiers, and the channel interfaces are topic post interfaces corresponding to the topic post identifiers.

18. The electronic device according to claim 14, wherein the processor for execution of the computer program in the memory is further to perform:
in a case that the historical reading status comprises a latest reading progress and a latest reading frequency, upon determining that the latest reading progress of a first book exceeds a first progress threshold and the latest reading frequency exceeds a first frequency threshold, using a preset Recently Frequent Reading tag as the presentation tag corresponding to the first book; or
in a case that the historical reading status comprises a latest reading progress, upon determining that the latest reading progress corresponding to a first book exceeds a second progress threshold, using a Reading Progress tag characterizing the latest reading progress or a Progress Delay tag characterizing a number of currently unread chapters as the presentation tag corresponding the first book; or
in a case that the historical reading status comprises a latest reading frequency, upon determining that the latest reading frequency of a first book exceeds a second frequency threshold, using a Frequent Reading tag characterizing the latest reading frequency as the presentation tag corresponding to the first book.

19. The electronic device according to claim 18, wherein the first book is also labelled with a channel tag characterizing its access channel; and wherein the processor for execution of the computer program in the memory is further to perform:
using the preset Recently Frequent Reading tag as the presentation tag corresponding to the first book comprises:
using the Recently Frequent Reading tag as the presentation tag corresponding to the first book upon determining that a priority corresponding to the Recently Frequent Reading tag is higher than a priority corresponding to the channel tag.

20. A non-transitory computer-readable storage medium having program codes stored thereon which, when executed by a computer, cause the computer to:
retrieve, in response to a user's access request for a read history page, book basic information corresponding to first books, each first book being a book historically read by the user;
retrieve presentation tags corresponding to respective first books, wherein the presentation tags are determined based on interactive information of respective first books; and
display, on the read history page, the book basic information and the presentation tags corresponding to the first books.
